(19) United States
(12) Patent Application Publication
(10) Pub. No.: US 2019/0026626 A1
(43) Pub. Date: Jan. 24, 2019

(54) NEURAL NETWORK ACCELERATOR AND OPERATION METHOD THEREOF

(71) Applicant: Institute of Computing Technology, Chinese Academy of Sciences, Beijing (CN)

(72) Inventors: Zidong Du, Beijing (CN); Qi Guo, Beijing (CN); Tianshi Chen, Beijing (CN); Yunji Chen, Beijing (CN)

(21) Appl. No.: 16/071,801

(22) PCT Filed: Aug. 9, 2016
(86) PCT No.: PCT/CN2016/094179

§ 371 Date: Jul. 20, 2018

(30) Foreign Application Priority Data
Mar. 28, 2016 (CN) 201610183040.3

(51) Int. Cl. G06N 3/063; G06F 7/575

(52) U.S. Cl. CPC G06N 3/063; G06F 7/575

(57) ABSTRACT

A neural network accelerator and an operation method thereof applicable in the field of neural network algorithms are disclosed. The neural network accelerator comprises an on-chip storage medium for storing data externally transmitted or for storing data generated during computing; an on-chip address index module for mapping to a correct storage address on the basis of an input index when an operation is performed; a core computing module for performing a neural network operation; and a multi-ALU device for obtaining input data from the core computing module or the on-chip storage medium to perform a nonlinear operation which cannot be completed by the core computing module. By introducing a multi -ALU design into the neural network accelerator, an operation speed of the nonlinear operation is increased, such that the neural network accelerator is more efficient.

### TECHNICAL FIELD

The present invention relates to the field of neural network algorithms, and belongs to a neural network accelerator and an operation method thereof.

### BACKGROUND ART

In the era of big data, more and more devices, such as an industrial robot, an unmanned car of automatic drive and a mobile device, etc., are required to perform complex processing on real-time input of the real world. Most of these tasks relates to the machine learning field, in which most of the operations are vector operations or matrix operations having high degree of parallelism. As compared to the conventional general GPU/CPU acceleration scheme, the hardware ASIC accelerator is currently the most popular acceleration scheme. On one hand, it can provide high degree of parallelism and achieve high performance, and on the other hand, it has high energy efficiency.

The common neural network algorithms comprise the most popular Multi-Layer Perceptron (MLP) neural network, Convolutional Neural Network (CNN), and Deep Neural Network (DNN), most of which are nonlinear neural networks. The nonlinearity may be resulted from activation function, such as sigmoid function, tanh function, or nonlinear layer, such as ReLU. Generally, these nonlinear operations are independent from other operations, i.e., input and output are one-to-one mapped, and are at the final stage of the output neuron, i.e., only if the nonlinear operations are finished, the computation for a next layer of neural network can be performed, so the operation speed of nonlinear operation has a great effect on the performance of the neural network accelerator. In the neural network accelerator, these nonlinear operations are performed by using a single Arithmetic Logic Unit (ALU) or a simplified ALU; however, the performance of the neural network accelerator may be degraded.

In view of above, the prior art obviously is inconvenient and defective in practical use, so it requires improvement.

### DISCLOSURE OF THE PRESENT INVENTION

With respect to the above deficiencies, an object of the present invention is to provide a neural network accelerator and an operation method thereof, which introduces a multi-ALU design into the neural network accelerator to increase an operation speed of the nonlinear operations, such that the neural network accelerator is more efficient.

In order to achieve the object, the present invention provides a neural network accelerator, comprising an on-chip storage medium for storing data transmitted from an external of the neural network accelerator or for storing data generated during computation; an on-chip address index module for mapping to a correct storage address on the basis of an input index when an operation is performed; a core computing module for performing a linear operation of a neural network operation; and a multi-ALU device for obtaining input data from the core computing module or the on-chip storage medium to perform a nonlinear operation which cannot be performed by the core computing module.

According to the neural network accelerator of the present invention, the data generated during computation comprises a computation result or an intermediate computation result.

According to the neural network accelerator of the present invention, the multi-ALU device comprises: an input mapping unit, a plurality of arithmetic logical units (ALUs) and an output mapping unit,

the input mapping unit is configured for mapping the input data obtained from the on-chip storage medium or the core computing module to the plurality of ALUs;

the plurality of ALUs are configured for performing a logical operation including the nonlinear operation on the basis of the input data; and

the output mapping unit is configured for integrating and mapping computation results obtained from the plurality of ALUs to a correct format for subsequent storage or for other module to use.

According to the neural network accelerator of the present invention, the input mapping unit distributes the input data to the plurality of ALUs for performing different operations respectively, or maps a plurality of input data to the plurality of ALUs in one-to-one manner for performing operation.

According to the neural network accelerator of the present invention, the plurality of ALUs have isomorphic design or isomeric design.

According to the neural network accelerator of the present invention, each of the ALUs comprises a plurality of sub-operating units for performing different functions.

According to the neural network accelerator of the present invention, the multi-ALU device configures an operation function performed by the respective ALUs on the basis of a control signal when computing.

According to the neural network accelerator of the present invention, the on-chip storage medium comprises a Static Random Access Memory (SRAM), a Dynamic Random Access Memory (DRAM), an Enhanced Dynamic Random Access Memory (e-DRAM), a Register file (RF), or a Non-Volatile Memory (NVM).

The present invention correspondingly provides an operation method using the above neural network accelerator, comprising:

selecting a multi-ALU device or a core computing module to perform computation on the basis of a control signal;

if selecting the core computing module to perform computation, obtaining data from an on-chip storage medium to perform a linear operation; and

if selecting the multi-ALU device to perform computation, obtaining input data from the on-chip storage medium or the core computing module to perform a nonlinear operation which cannot be performed by the core computing module.

According to the operation method of the neural network accelerator of the present invention, the step of selecting the multi-ALU device to perform computation further comprises: configuring, by the multi-ALU device, an operation function performed by respective ALUs on the basis of a control signal.

### BRIEF DESCRIPTION OF THE DRAWINGS

FIG. 1 is a structure diagram of a neural network accelerator according to the present invention.

FIG. 2 is a structure diagram of a multi-ALU device according to one embodiment of the present invention.

FIG. 3 is a block diagram of function implementation of a single ALU according to one embodiment of the present invention.

FIG. 4 is a block diagram of function distribution of a plurality of ALUs according to one embodiment of the present invention.

FIG. 5 is a flow diagram of the neural network operation of the neural network accelerator shown in FIG. 1.

FIG. 6 is an organization diagram of the core computing module of the neural network accelerator according to one embodiment of the present invention.

FIG. 7 is an organization diagram of the core computing module of the neural network accelerator according to another embodiment of the present invention.

### PREFERABLE EMBODIMENTS

In order to clarify the object, the technical solution and the advantages of the present invention, the present invention is further explained in detail with reference to the drawings and the embodiments. It shall be understood that the specific embodiments described herein are only provided to explain the present invention, not limiting the present invention.

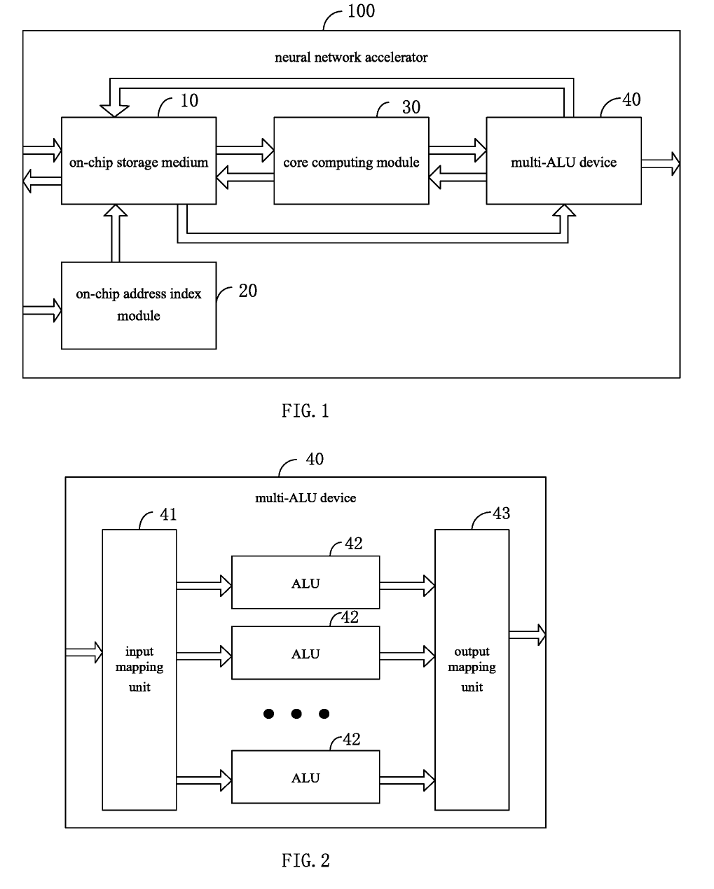

As shown in FIG. 1, the present invention provides a neural network accelerator 100, comprising an on-chip storage medium 10, an on-chip address index module 20, a core computing module 30 and a multi-ALU device 40. The on-chip address index module 20 is connected to the on-chip storage medium 10, and the on-chip address index module 20, the core computing module 30 and the multi-ALU device 40 are connected to each other.

The on-chip storage medium 10 stores data transmitted from an external of the neural network accelerator or stores data generated during computation. The data generated during computation comprises a computation result or an intermediate computation result generated during computation. These results may come from the on-chip core computing module 30 of the accelerator, and also may come from other operating element, such as the multi-ALU device 40 of the present invention. The on-chip storage medium 10 may be commonly used storage medium, such as a Static Random Access Memory (SRAM), a Dynamic Random Access Memory (DRAM), an Enhanced Dynamic Random Access Memory (e-DRAM), a Register file (RF) and the like, and also may be a novel storage device, such as a Non-Volatile Memory (NVM), or a 3D storage device.

The on-chip address index module 20 maps to a correct storage address on the basis of an input index when an operation is performed, such that data can correctly interact with the on-chip storage module. Herein, the address mapping process comprises directly mapping, arithmetic transformation and the like.

The core computing module 30 performs the linear operation of the neural network operation. Specifically, the core computing module 30 performs most of the operations, i.e., vector multiplication and addition operations, in the neural network algorithms.

The multi-ALU device 40 obtains input data from the core computing module or the on-chip storage medium to perform the nonlinear operation which cannot be performed by the core computing module. In the present invention, the multi-ALU device is mainly used for the nonlinear operation, so as to increase an operation speed of the nonlinear operation, such that the neural network accelerator is more efficient. In the present invention, the data channels between the core computing module 30, the multi-ALU device 40 and the on-chip storage medium 10 includes, but not limited to H-TREE, FAT-TREE or other interconnection technique.

As shown in FIG. 2, the multi-ALU device 40 comprises an input mapping unit 41, a plurality of arithmetic logical units (ALUs) 42 and an output mapping unit 43.

The input mapping unit 41 maps the input data obtained from the on-chip storage medium or the core computing module to the plurality of ALUs 42. The principle for data distribution may vary according to the design of the accelerator. According to the principle for data distribution, the input mapping unit 41 distributes the input data to the plurality of ALUs 42 for performing different operations, respectively, or maps a plurality of input data to the plurality of ALUs 42 in one-to-one manner for performing operations. Herein, the input data may be directly obtained from the on-chip storage medium 10, or obtained from the core computing module 30.

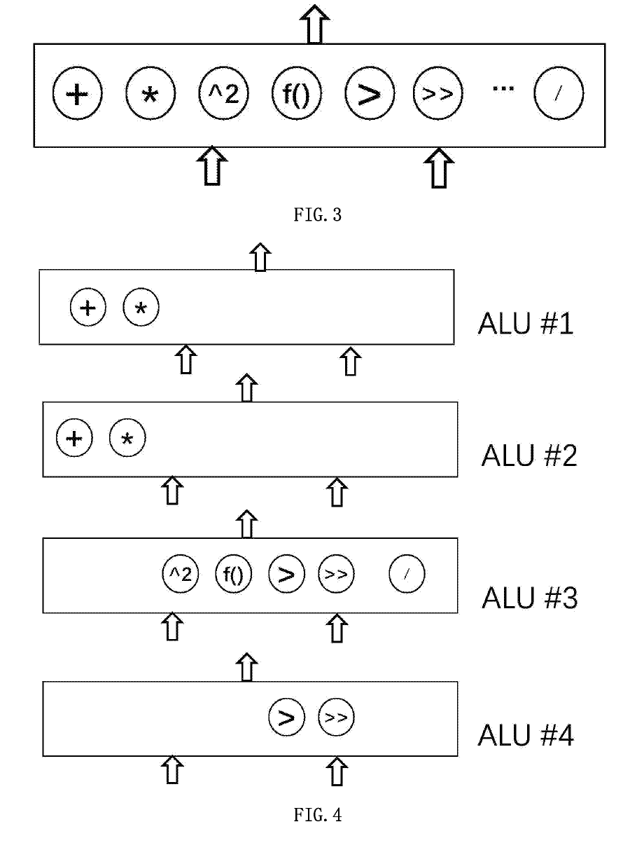

The plurality of ALUs 42 perform the logical operations including the nonlinear operation on the basis of the input data, respectively. A single ALU 42 comprises a plurality of sub-operating units for performing different functions. As shown in FIG. 3, the functions of the single ALU 42 comprise operations of multiplication, addition, comparison, division, shifting and the like, and also comprise complex functions, such as index operation. The single ALU 42 comprises one or more sub-operating units for performing the above-mentioned different functions. Meanwhile, the functions of the ALUs 42 may be determined by the function of the neural network accelerator, and is not limited to a specific algorithm operation.

The plurality of ALUs 42 may have isomorphic design or isomeric design, i.e., the ALUs 42 can implement the same function or different functions. In the embodiment shown in FIG. 4, the functions of the plurality of ALUs 42 are isomeric, the above two ALUs implement operations of multiplication and addition, and other ALUs implement other complex functions, respectively. The isomeric design facilitates effectively balancing the functionality and overhead of the ALUs.

The output mapping unit 43 integrates and maps the computation results obtained from the plurality of ALUs 42 to a correct format for subsequent storage or for other module to use.

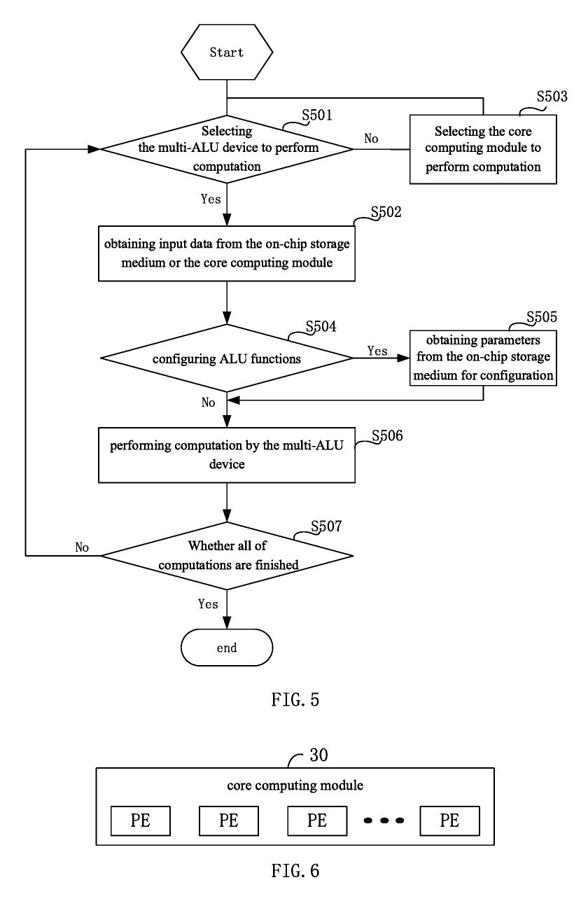

FIG. 5 is a flow diagram of the neural network operation of the neural network accelerator shown in FIG. 1. The flow comprises:

Step S501, for determining whether the multi-ALU device is selected to perform computation on the basis of a control signal. If yes, goes to step S502, or otherwise, goes to step S503. In the present invention, the control signal is implemented by the control instruction, direct signal and the like.

Step S502, for obtaining the input data from the on-chip storage medium or the core computing module. Step S502 is followed by step S504. Generally, if the nonlinear operation occurs after the completion of the core computation, the input data is obtained from the core computing module, and if the intermediate computation result cached in the on-chip storage medium is input for computation, the input data is obtained from the on-chip storage medium.

Step S503, for selecting the core computing module to perform computation. Specifically, the core computing module 30 obtains data from the on-chip storage medium to perform linear operation, and the core computing module 30 performs most of the operations, i.e., vector multiplication and addition operations, in the neural network algorithms.

Step S504, for determining whether to configure the function of ALU. If yes, goes to step S505, or otherwise, directly goes to step S506. Specifically, the multi-ALU device 40 determines whether the device itself requires to be configured correspondingly to control operation of the respective ALUs 42, such as the specific function to be performed by the ALU 42, on the basis of the control signal. That is, the multi-ALU device 40 configures the operation performed by the respective ALUs on the basis of the control signal when performing computation.

Step S505, for obtaining parameters from the on-chip storage medium for configuration. After the configuration is finished, goes to step S506.

Step S506, for performing computation by the multi-ALU device 40. The multi-ALU device 40 performs the nonlinear operation which cannot be performed by the core computing module 30.

Step S507, for determining whether all of the computations are finished. If yes, goes to ‘end’, or otherwise, goes back to step S501 for continuing with computation.

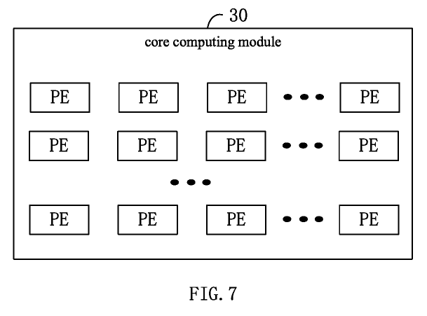

In one embodiment of the present invention, the core computing module 30 may vary in structure, for example, the core computing module 30 may be implemented as one-dimensional processing element (PE) in FIG. 6, or two-dimensional PE in FIG. 7. In FIG. 6, a plurality of PEs simultaneously perform computation, which generally includes isomorphic operation, for example, in the commonly used vector operating accelerator. According to the two-dimensional PE of FIG. 7, a plurality of PEs generally perform isomorphic computation; however, the plurality of PEs may transmit data in two dimensions, for example, in the commonly used accelerator of matrix structure, such as two-dimensional Systolic structure.

In conclusion, the present invention provides a neural network accelerator having a multi-ALU device for obtaining input data from the core computing module or the on-chip storage medium to perform nonlinear operation which cannot be performed by the core computing module. The present invention increases an operation speed of the nonlinear operation, and thereby the neural network accelerator is more efficient.

Certainly, the present invention may have other embodiments, and those skilled in the art may make corresponding modifications and variations on the basis of the present invention, without departing from the spirit and substance of the present invention. Such corresponding modifications and variations shall fall into the scope claimed by the appended claims.

### INDUSTRIAL APPLICABILITY

The present invention provides a neural network accelerator having a multi-ALU device for obtaining input data from the core computing module or the on-chip storage medium to perform operations, mainly including nonlinear operations, which cannot be performed by the core computing module. As compared to the current design of neural network accelerator, the present invention increases an operation speed of the nonlinear operations, and thereby the neural network accelerator is more efficient.

1. A neural network accelerator, comprising:
an on-chip storage medium for storing data transmitted from an external of the neural network accelerator or for storing data generated during computation;
an on-chip address index module for mapping to a correct storage address on the basis of an input index when an operation is performed;
a core computing module for performing a linear operation of a neural network operation; and
a multi-ALU device for obtaining input data from the core computing module or the on-chip storage medium to perform a nonlinear operation which cannot be performed by the core computing module.

2. The neural network accelerator according to claim 1, wherein the data generated during computation comprises a computation result or an intermediate computation result.

3. The neural network accelerator according to claim 1, wherein the multi-ALU device comprises: an input mapping unit, a plurality of arithmetic logical units (ALUs) and an output mapping unit,
the input mapping unit is configured for mapping the input data obtained from the on-chip storage medium or the core computing module to the plurality of ALUs,
the plurality of ALUs are configured for performing a logical operation including the nonlinear operation on the basis of the input data, and
the output mapping unit is configured for integrating and mapping the computation results obtained from the plurality of ALUs to a correct format for subsequent storage or for other module to use.

4. The neural network accelerator according to claim 3, wherein the input mapping unit distributes the input data to the plurality of ALUs for performing different operations respectively, or maps a plurality of input data to the plurality of ALUs in one-to-one manner for performing operations.

5. The neural network accelerator according to claim 3, wherein the plurality of ALUs have isomorphic design or isomeric design.

6. The neural network accelerator according to claim 3, wherein each of the ALUs comprises a plurality of sub-operating units for performing different functions.

7. The neural network accelerator according to claim 3, wherein the multi-ALU device configures an operation function performed by the respective ALUs on the basis of a control signal when computing.

8. The neural network accelerator according to claim 1, wherein the on-chip storage medium comprises a Static Random Access Memory (SRAM), a Dynamic Random Access Memory (DRAM), an Enhanced Dynamic Random Access Memory (e-DRAM), a Register file (RF), or a Non-Volatile Memory (NVM).

9. An operation method of the neural network accelerator, the neural network accelerator comprising: an on-chip storage medium for storing data transmitted from an external of the neural network accelerator or for storing data generated during computation; an on-chip address index module for mapping to a correct storage address on the basis of an input index when an operation is performed; a core computing module for performing a linear operation of a neural network operation; and a multi-ALU device for obtaining input data from the core computing module or the on-chip storage medium to perform a nonlinear operation which cannot be performed by the core computing module;
the operation method comprising:
selecting a multi-ALU device or a core computing module to perform computation on the basis of a control signal;
if selecting the core computing module to perform computation, obtaining data from an on-chip storage medium to perform a linear operation; and
if selecting the multi-ALU device to perform computation, obtaining input data from the on-chip storage medium or the core computing module to perform a nonlinear operation which cannot be performed by the core computing module.

10. The operation method of the neural network accelerator according to claim 9, wherein the step of selecting the multi-ALU device to perform computation further comprises:
configuring, by the multi-ALU device, an operation function performed by respective ALUs on the basis of a control signal.

11. An operation method of the neural network accelerator, the neural network accelerator comprising: an on-chip storage medium for storing data transmitted from an external of the neural network accelerator or for storing data generated during computation, wherein the data generated during computation comprises a computation result or an intermediate computation result; an on-chip address index module for mapping to a correct storage address on the basis of an input index when an operation is performed; a core computing module for performing a linear operation of a neural network operation; and a multi-ALU device for obtaining input data from the core computing module or the on-chip storage medium to perform a nonlinear operation which cannot be performed by the core computing module;
the operation method comprising:
selecting a multi-ALU device or a core computing module to perform computation on the basis of a control signal;
if selecting the core computing module to perform computation, obtaining data from an on-chip storage medium to perform a linear operation; and
if selecting the multi-ALU device to perform computation, obtaining input data from the on-chip storage medium or the core computing module to perform a nonlinear operation which cannot be performed by the core computing module.

12. The operation method of the neural network accelerator according to claim 11, wherein the step of selecting the multi-ALU device to perform computation further comprises:
configuring, by the multi-ALU device, an operation function performed by respective ALUs on the basis of a control signal.

13. An operation method of the neural network accelerator, the neural network accelerator comprising: an on-chip storage medium for storing data transmitted from an external of the neural network accelerator or for storing data generated during computation; an on-chip address index module for mapping to a correct storage address on the basis of an input index when an operation is performed; a core computing module for performing a linear operation of a neural network operation; and a multi-ALU device for obtaining input data from the core computing module or the on-chip storage medium to perform a nonlinear operation which cannot be performed by the core computing module, comprises: an input mapping unit, a plurality of arithmetic logical units (ALUs) and an output mapping unit, the input mapping unit is configured for mapping the input data obtained from the on-chip storage medium or the core computing module to the plurality of ALUs, the plurality of ALUs are configured for performing a logical operation including the nonlinear operation on the basis of the input data, and the output mapping unit is configured for integrating and mapping the computation results obtained from the plurality of ALUs to a correct format for subsequent storage or for other module to use;
the operation method comprising:
selecting a multi-ALU device or a core computing module to perform computation on the basis of a control signal;
if selecting the core computing module to perform computation, obtaining data from an on-chip storage medium to perform a linear operation; and
if selecting the multi-ALU device to perform computation, obtaining input data from the on-chip storage medium or the core computing module to perform a nonlinear operation which cannot be performed by the core computing module.

14. The operation method of the neural network accelerator according to claim 13, wherein the step of selecting the multi-ALU device to perform computation further comprises:
configuring, by the multi-ALU device, an operation function performed by respective ALUs on the basis of a control signal.

15. An operation method of the neural network accelerator, the neural network accelerator comprising: an on-chip storage medium for storing data transmitted from an external of the neural network accelerator or for storing data generated during computation; an on-chip address index module for mapping to a correct storage address on the basis of an input index when an operation is performed; a core computing module for performing a linear operation of a neural network operation; and a multi-ALU device for obtaining input data from the core computing module or the on-chip storage medium to perform a nonlinear operation which cannot be performed by the core computing module, comprises: an input mapping unit, a plurality of arithmetic logical units (ALUs) and an output mapping unit, the input mapping unit is configured for mapping the input data obtained from the on-chip storage medium or the core computing module to the plurality of ALUs, the plurality of ALUs are configured for performing a logical operation including the nonlinear operation on the basis of the input data, and the output mapping unit is configured for integrating and mapping the computation results obtained from the plurality of ALUs to a correct format for subsequent storage or for other module to use, the input mapping unit distributes the input data to the plurality of ALUs for performing different operations respectively, or maps a plurality of input data to the plurality of ALUs in one-to-one manner for performing operations;
the operation method comprising:
selecting a multi-ALU device or a core computing module to perform computation on the basis of a control signal;
if selecting the core computing module to perform computation, obtaining data from an on-chip storage medium to perform a linear operation; and
if selecting the multi-ALU device to perform computation, obtaining input data from the on-chip storage medium or the core computing module to perform a nonlinear operation which cannot be performed by the core computing module.

16. The operation method of the neural network accelerator according to claim 15, wherein the step of selecting the multi-ALU device to perform computation further comprises:
configuring, by the multi-ALU device, an operation function performed by respective ALUs on the basis of a control signal.

17. An operation method of the neural network accelerator, the neural network accelerator comprising: an on-chip storage medium for storing data transmitted from an external of the neural network accelerator or for storing data generated during computation; an on-chip address index module for mapping to a correct storage address on the basis of an input index when an operation is performed; a core computing module for performing a linear operation of a neural network operation; and a multi-ALU device for obtaining input data from the core computing module or the on-chip storage medium to perform a nonlinear operation which cannot be performed by the core computing module, comprises: an input mapping unit, a plurality of arithmetic logical units (ALUs) and an output mapping unit, the input mapping unit is configured for mapping the input data obtained from the on-chip storage medium or the core computing module to the plurality of ALUs, the plurality of ALUs are configured for performing a logical operation including the nonlinear operation on the basis of the input data, and the output mapping unit is configured for integrating and mapping the computation results obtained from the plurality of ALUs to a correct format for subsequent storage or for other module to use; the plurality of ALUs have isomorphic design or isomeric design;
the operation method comprising:
selecting a multi-ALU device or a core computing module to perform computation on the basis of a control signal;
if selecting the core computing module to perform computation, obtaining data from an on-chip storage medium to perform a linear operation; and
if selecting the multi-ALU device to perform computation, obtaining input data from the on-chip storage medium or the core computing module to perform a nonlinear operation which cannot be performed by the core computing module.

18. The operation method of the neural network accelerator according to claim 17, wherein the step of selecting the multi-ALU device to perform computation further comprises:
configuring, by the multi-ALU device, an operation function performed by respective ALUs on the basis of a control signal.

19. An operation method of the neural network accelerator, the neural network accelerator comprising: an on-chip storage medium for storing data transmitted from an external of the neural network accelerator or for storing data generated during computation; an on-chip address index module for mapping to a correct storage address on the basis of an input index when an operation is performed; a core computing module for performing a linear operation of a neural network operation; and a multi-ALU device for obtaining input data from the core computing module or the on-chip storage medium to perform a nonlinear operation which cannot be performed by the core computing module, comprises: an input mapping unit, a plurality of arithmetic logical units (ALUs) and an output mapping unit, the input mapping unit is configured for mapping the input data obtained from the on-chip storage medium or the core computing module to the plurality of ALUs, the plurality of ALUs are configured for performing a logical operation including the nonlinear operation on the basis of the input data, and the output mapping unit is configured for integrating and mapping the computation results obtained from the plurality of ALUs to a correct format for subsequent storage or for other module to use; each of the ALUs comprises a plurality of sub-operating units for performing different functions;
the operation method comprising:
selecting a multi-ALU device or a core computing module to perform computation on the basis of a control signal;
if selecting the core computing module to perform computation, obtaining data from an on-chip storage medium to perform a linear operation; and
if selecting the multi-ALU device to perform computation, obtaining input data from the on-chip storage medium or the core computing module to perform a nonlinear operation which cannot be performed by the core computing module.

20. The operation method of the neural network accelerator according to claim 19, wherein the step of selecting the multi-ALU device to perform computation further comprises:
configuring, by the multi-ALU device, an operation function performed by respective ALUs on the basis of a control signal.

21. An operation method of the neural network accelerator, the neural network accelerator comprising: an on-chip storage medium for storing data transmitted from an external of the neural network accelerator or for storing data generated during computation; an on-chip address index module for mapping to a correct storage address on the basis of an input index when an operation is performed; a core computing module for performing a linear operation of a neural network operation; and a multi-ALU device for obtaining input data from the core computing module or the on-chip storage medium to perform a nonlinear operation which cannot be performed by the core computing module, comprises: an input mapping unit, a plurality of arithmetic logical units (ALUs) and an output mapping unit, the input mapping unit is configured for mapping the input data obtained from the on-chip storage medium or the core computing module to the plurality of ALUs, the plurality of ALUs are configured for performing a logical operation including the nonlinear operation on the basis of the input data, and the output mapping unit is configured for integrating and mapping the computation results obtained from the plurality of ALUs to a correct format for subsequent storage or for other module to use; the multi-ALU device configures an operation function performed by the respective ALUs on the basis of a control signal when computing;
the operation method comprising:
selecting a multi-ALU device or a core computing module to perform computation on the basis of a control signal;
if selecting the core computing module to perform computation, obtaining data from an on-chip storage medium to perform a linear operation; and
if selecting the multi-ALU device to perform computation, obtaining input data from the on-chip storage medium or the core computing module to perform a nonlinear operation which cannot be performed by the core computing module.

22. The operation method of the neural network accelerator according to claim 21, wherein the step of selecting the multi-ALU device to perform computation further comprises:
configuring, by the multi-ALU device, an operation function performed by respective ALUs on the basis of a control signal.

23. An operation method of the neural network accelerator, the neural network accelerator comprising: an on-chip storage medium for storing data transmitted from an external of the neural network accelerator or for storing data generated during computation, the on-chip storage medium comprises a Static Random Access Memory (SRAM), a Dynamic Random Access Memory (DRAM), an Enhanced Dynamic Random Access Memory (e-DRAM), a Register file (RF), or a Non-Volatile Memory (NVM).
; an on-chip address index module for mapping to a correct storage address on the basis of an input index when an operation is performed; a core computing module for performing a linear operation of a neural network operation; and a multi-ALU device for obtaining input data from the core computing module or the on-chip storage medium to perform a nonlinear operation which cannot be performed by the core computing module;
the operation method comprising:
selecting a multi-ALU device or a core computing module to perform computation on the basis of a control signal;
if selecting the core computing module to perform computation, obtaining data from an on-chip storage medium to perform a linear operation; and
if selecting the multi-ALU device to perform computation, obtaining input data from the on-chip storage medium or the core computing module to perform a nonlinear operation which cannot be performed by the core computing module.

24. The operation method of the neural network accelerator according to claim 23, wherein the step of selecting the multi-ALU device to perform computation further comprises:
configuring, by the multi-ALU device, an operation function performed by respective ALUs on the basis of a control signal.
